(19) United States
(12) Patent Application Publication
(10) Pub. No.: US 2005/0099588 A1
(43) Pub. Date: May 12, 2005

(54) Lens arrangements that are polarized and oriented for glare reduction and enhanced visualization of light emitted by liquid crystal displays

(76) Inventors: Joseph A. Helpern, Cornwall, NY (US); Jens Jensen, Scarsdale, NY (US); Truman Brown, Cornwall, NY (US)

Correspondence Address: DORSEY & WHITNEY LLP;INTELLECTUAL PROPERTY DEPARTMENT, 250 PARK AVENUE, NEW YORK, NY, 10177, US

(21) Appl. No.: 10/851,722

(22) Filed: May 21, 2004

Related U.S. Application Data
(60) Provisional application No. 60/473,757, filed on May 28, 2003.

(51) Int. Cl. G02C 7/10; G02C 7/12

(52) U.S. Cl. 351/44

(57) ABSTRACT

An arrangement adapted for viewing at least one liquid crystal display includes at least one lens provided in a particular orientation so as to at least partially reduce attenuation of a polarized light emitted by the at least one liquid crystal display. Another arrangement adapted for viewing at least one liquid crystal display includes at least one lens, having an upper portion and a lower portion, the upper portion being provided in a first orientation being arranged so as to at least partially reduce a glare from ambient light, the lower portion being provided in a second orientation being arranged so as to at least partially reduce attenuation of a polarized light emitted by the at least one liquid crystal display.

### PRIORITY AND RELATED APPLICATION

This application claims priority to U.S. Provisional Application Ser. No. 60/473,757 filed May 28, 2003, entitled “Lens Arrangements that are Polarized and Oriented for Glare Reduction and Enhanced Visualization of Light Emitted by Liquid Crystal Displays,” which is incorporated by reference herein in its entirety.

### FIELD OF THE PRESENT INVENTION

The present invention relates generally to lenses configured for use with polarized displays such as with liquid crystal displays (“LCDs”). More particularly, the present invention relates to polarized eyeglass lenses in which the direction of the polarization is oriented to optimize the viewing of the LCDs.

### BACKGROUND OF THE PRESENT INVENTION

LCDs are used on an ever increasing basis in many products, such as computers and automobiles, and outdoor viewing of LCDs is becoming common. However, because the light the LCD emits, and which is responsible for the contrast in the LCD display, is polarized, the ability to view an LCD may be substantially degraded by the use of polarized sunglasses, which are conventionally polarized in the vertical direction to minimize glare caused by reflected sunlight. Unless the LCD is also polarized in the vertical direction (which is often not the case due to either the construction of the LCD itself or its orientation in a product), then vertically polarized sunglasses are not optimal for viewing LCDs with maximum contrast. The optimal orientation depends both on the (fixed) direction of polarization of the LCD and on the desired amount of glare reduction.

Glare is largely polarized in the horizontal direction, because it is predominately generated by light reflecting from horizontal surfaces. If a lens is polarized at an angle θ₁ relative to the vertical direction, then the fraction of the horizontal (high glare) component of light that is transmitted is sin² θ₁. By choosing a vertical polarization (θ₁=0), the horizontal component can be entirely eliminated. This is the basis of conventional polarized sunglasses.

Thus, when using traditional polarized sunglasses, a user of a device having the LCD (e.g., a laptop computer, an automotive dashboard, etc.) may experience a significant reduction in visibility of the LCD screen. Therefore, there is a need to view the LCDs, while also shielding the viewer from glare from ambient light. There is also a need to improve the visualization of images generated by the LCD that are observed by the user.

### OBJECTS AND SUMMARY OF INVENTION

Accordingly, the present invention addresses these needs by providing a system that includes a frame assembly and at least one polarized lens oriented to achieve enhanced visualization of liquid crystal displays. It is preferable to provide two such lenses so that both lenses can provide this benefit.

In one exemplary embodiment of the present invention, an LCD can be provided which is polarized at an angle θ₂ relative to the vertical direction. When viewed through a polarized lens, the fraction of light transmitted is cos² (θ₁-θ₂), where θ₁ is the lens polarization angle. Therefore, the intensity and therefore the contrast thereof would likely be reduced, unless θ₁=θ₂. When using an LCD outdoors, it may be desirable to wear polarized sunglasses that are optimized not only for glare reduction but also for the viewing of the LCD. Thus, the optimal orientation for the lens polarization may deviate from the conventional vertical direction (unless the LCD happens to be polarized vertically). For example, when the polarization angle for the LCD, i.e., θ₂, is 45°. If the lenses are polarized vertically, then the glare reduction would likely be optimal. However, only 50% of the light produced by the LCD would be transmitted therethrough. In such case, it may be preferable to select the lens polarization angle, i.e., θ₁, to be 45° so that the lenses transmit all of the LCD light, while still filtering half of the horizontally polarized glare. Alternatively, under high glare conditions, one might wish to choose θ₁=22.5°, which will allow 85% of the LCD light to be transmitted, but only 15% of the horizontally polarized glare. As these considerations demonstrate, sunglasses that are polarized with an orientation other than vertical may be of practical utility for outdoor viewing of LCDs.

According to another exemplary embodiment of the present invention, the polarized lens(es) at least partially filter other unpolarized light (e.g., sunlight) by using lenses which are non-rotatable with respect to the eyeglass frame assembly. The polarized lens(es) can be oriented such that the attenuation of the light passing therethrough which originates from the LCD is minimized.

According to another exemplary embodiment of the present invention, the polarized lens(es) can partially filter unpolarized light being rotatable with respect to the eyeglass frame assembly, e.g., by orienting the polarization of the lenses in a particular manner over angles ranging from 0° to ±90° from vertical, so as to allow the polarization to be optimized for a particular LCD and a glare condition.

In still another exemplary embodiment of the present invention, the lens(es) can be polarized such that the attenuation of the light passing therethrough which originates from the LCD is minimized via a lower portion thereof (e.g., a bifocal lens), and the reduction of glare of all other unpolarized light is maximized via the upper portion thereof. Both lenses of such bifocal arrangement can be non-rotatable with respect to each other, and with respect to the eyeglass frame assembly.

### BRIEF DESCRIPTION OF THE DRAWINGS

FIG. 1(a) is a perspective view of a prior art lens arrangement.

FIGS. 11(b) and 1(c) are diagrammatic views illustrating the interaction between light displays and the polarized lens of a viewer using the lens arrangement of FIG. 1(a).

FIG. 2(a) is a perspective view of a first exemplary embodiment of a lens arrangement according to the present invention.

FIGS. 2(b) and 2(c) are diagrammatic views illustrating the interaction between light displays and the polarized lens of a viewer using the lens arrangement of FIG. 2(a).

FIG. 3(a) is a perspective view of a second exemplary embodiment of the lens arrangement according to the present invention.

FIGS. 3(b) and 3(c) are diagrammatic views illustrating the interaction between light displays and the polarized lens of a viewer using the lens arrangement of FIG. 3(a).

FIG. 4(a) is a perspective view of a third exemplary embodiment of the lens arrangement according to the present invention.

FIGS. 4(b) and 4(c) are diagrammatic views illustrating the interaction between light displays and the polarized lens of a viewer using the lens arrangement of FIG. 4(a).

FIGS. 5(a)-5(c) are perspective views still of fourth, fifth and sixth exemplary embodiments of the lens arrangement according to the present invention, where the user may select the orientation of the lenses.

FIG. 6 is a perspective view of a seventh exemplary embodiment of the lens arrangement according to the present invention.

### DETAILED DESCRIPTION OF THE PRESENT INVENTION

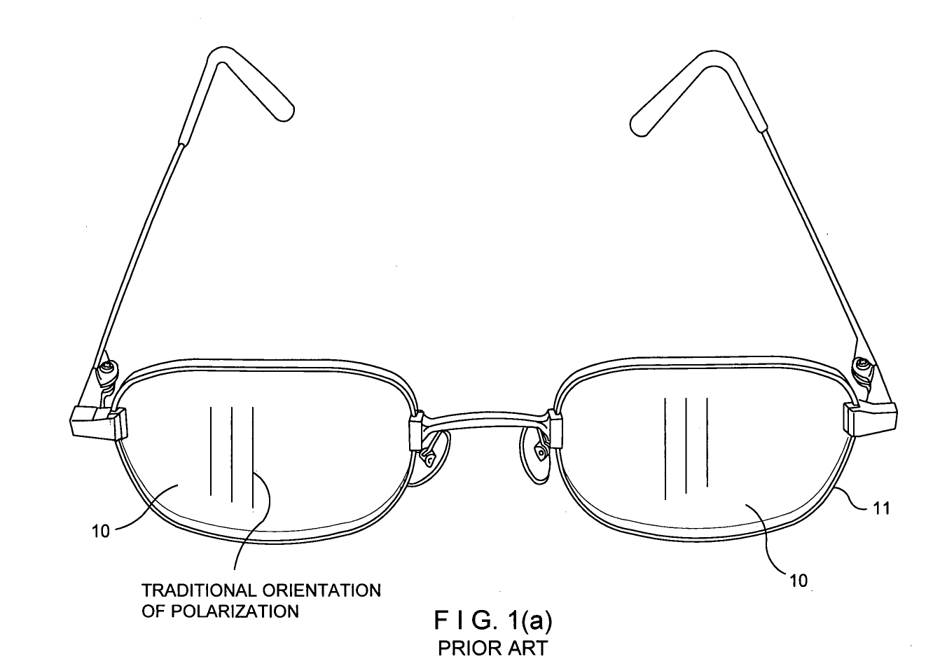

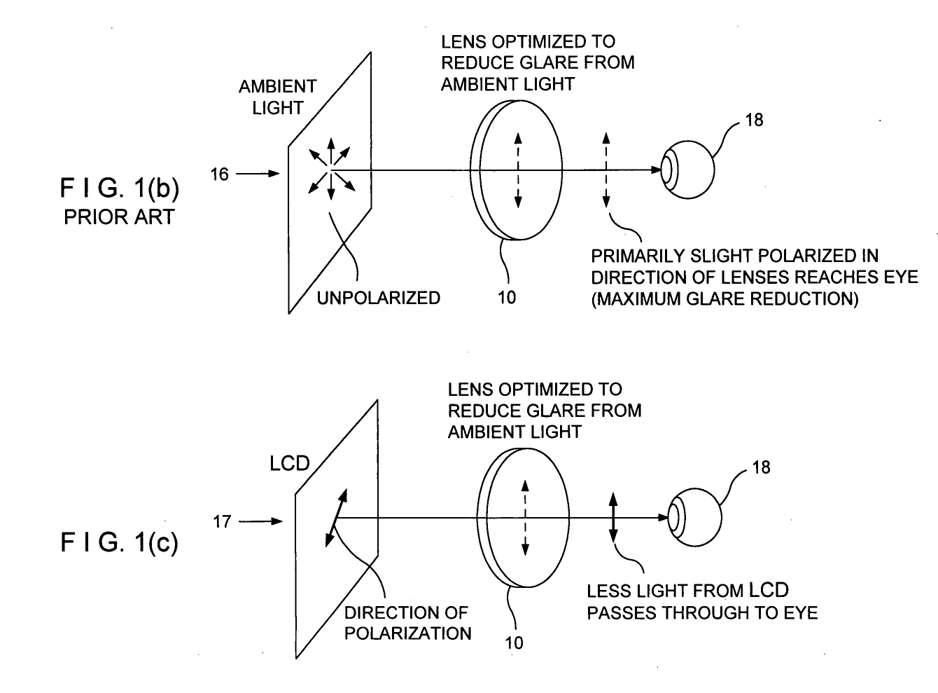

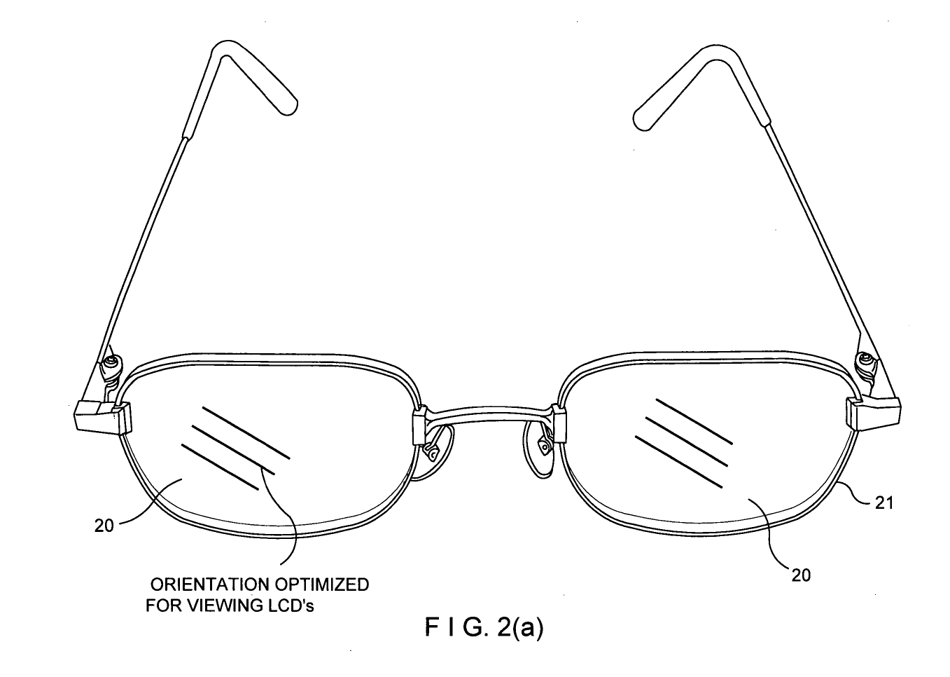

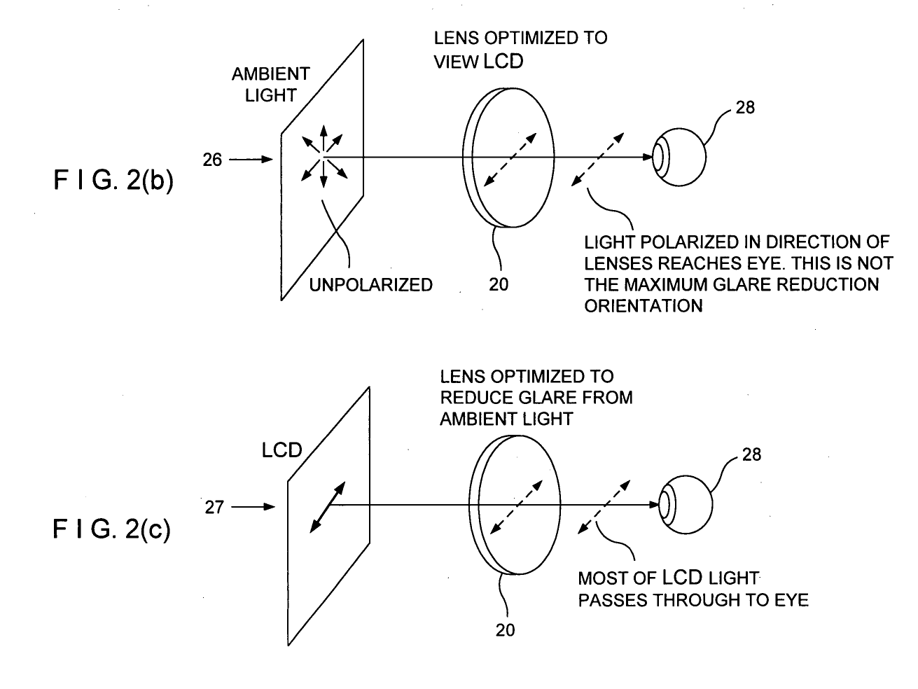

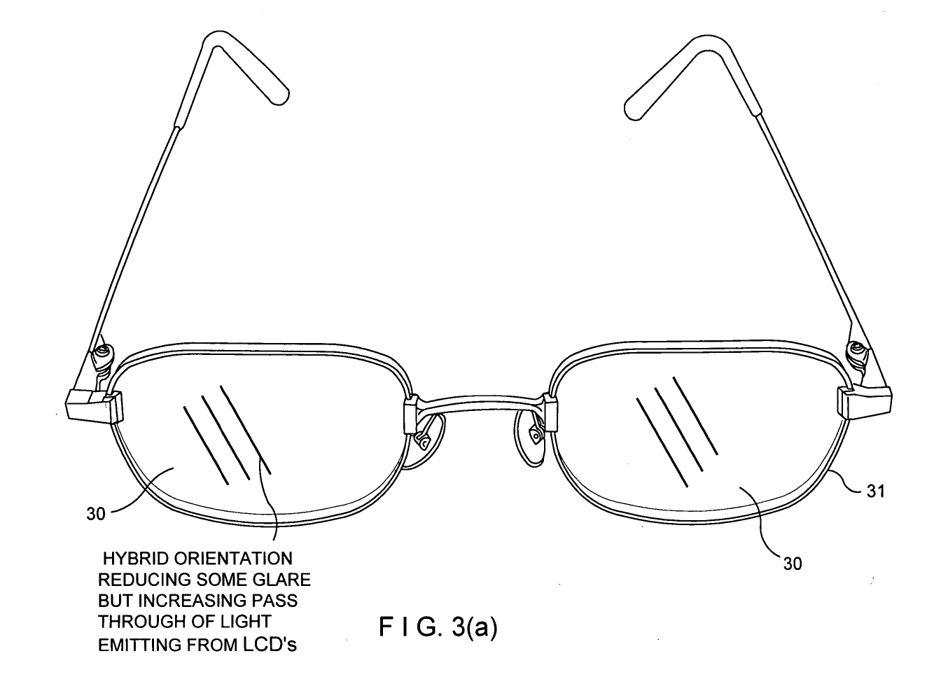

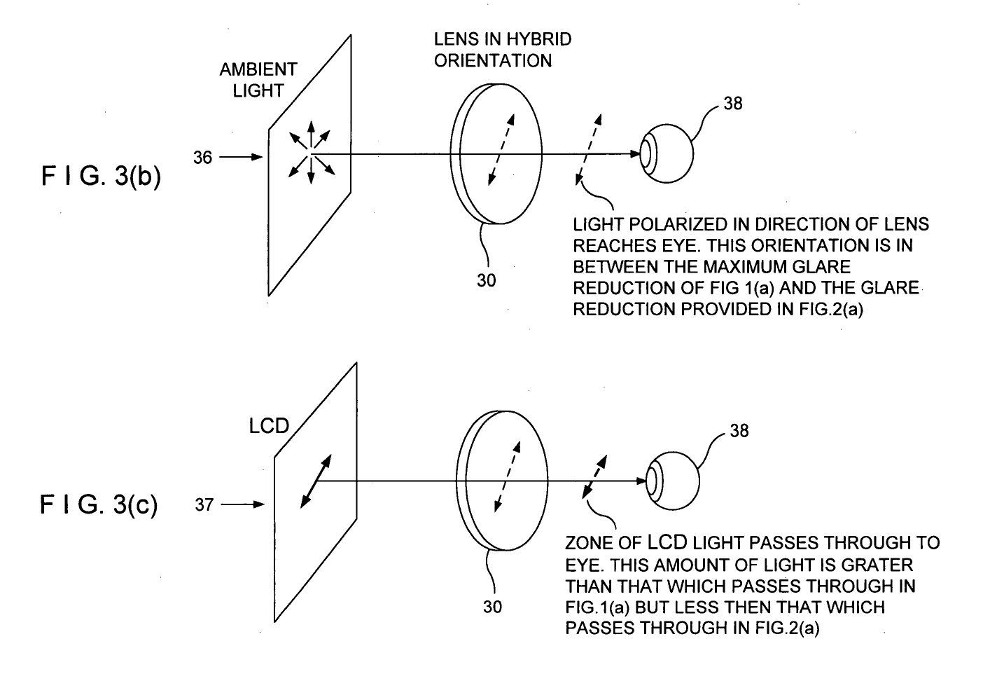

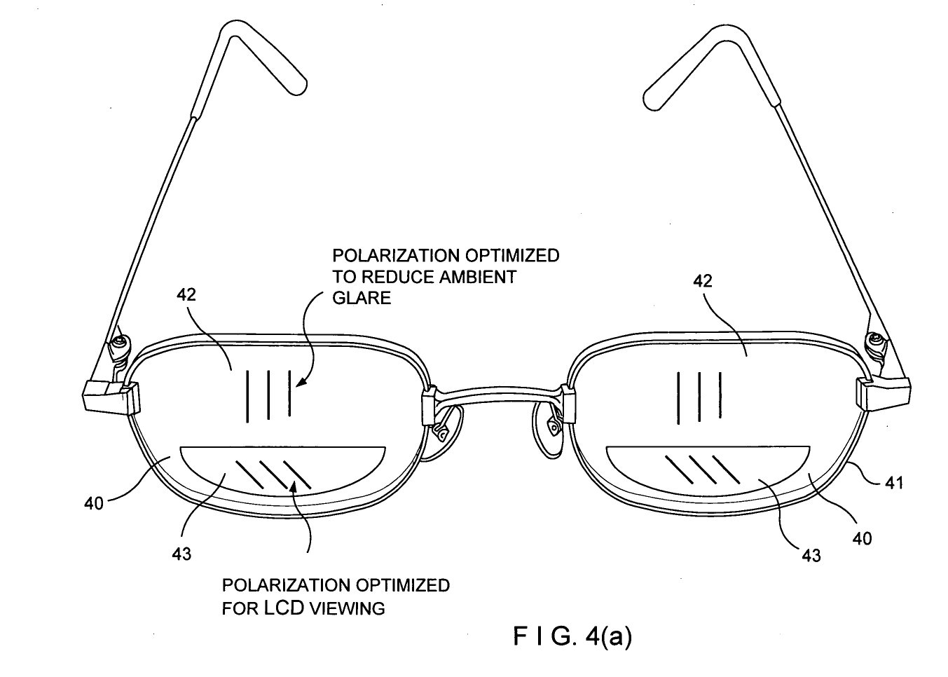

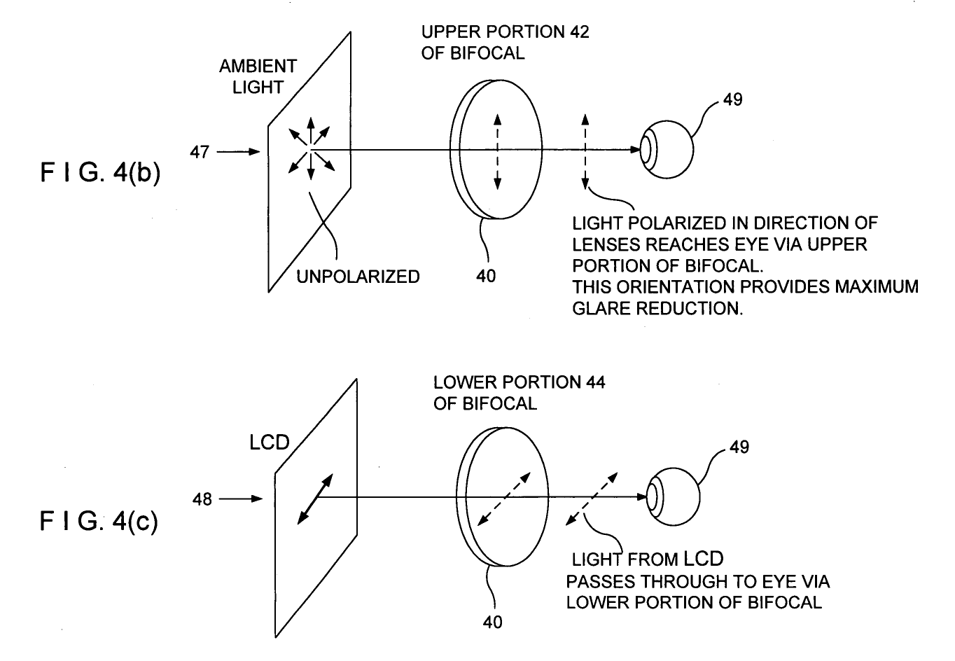

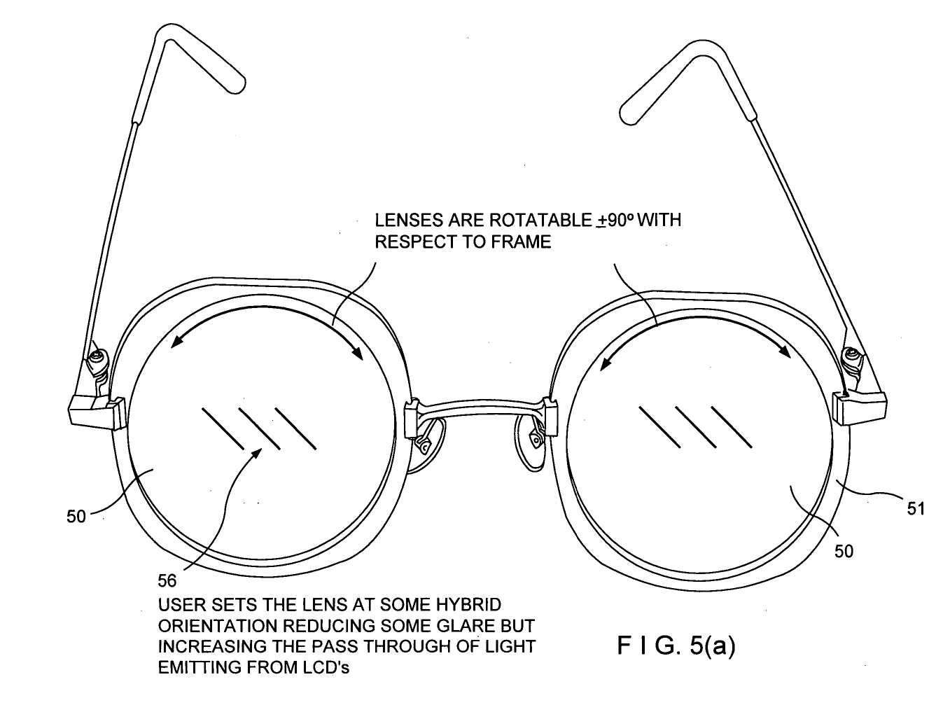

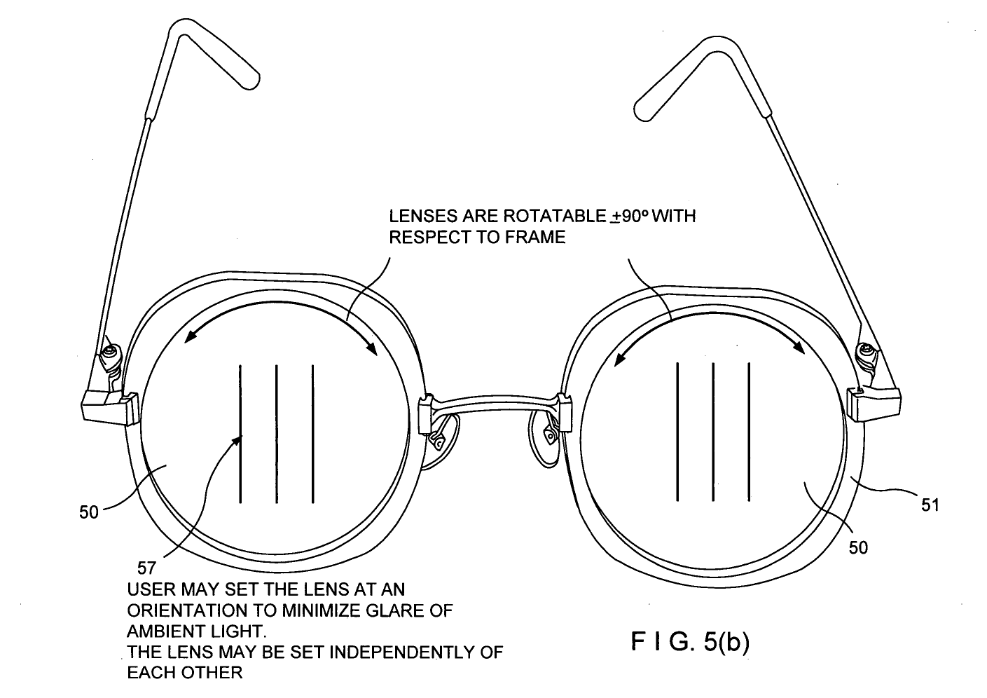

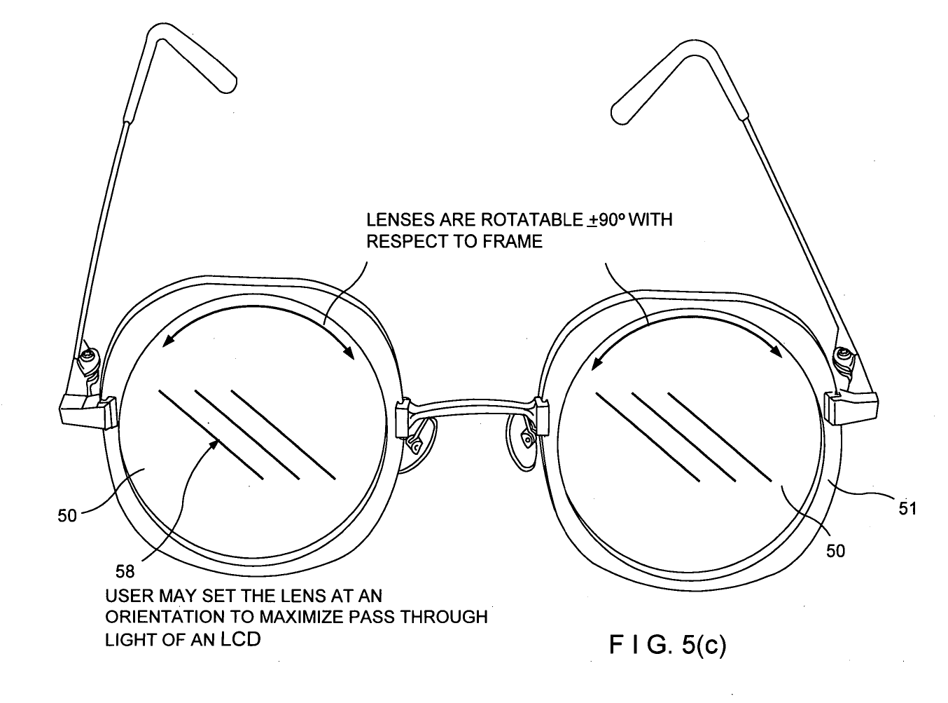

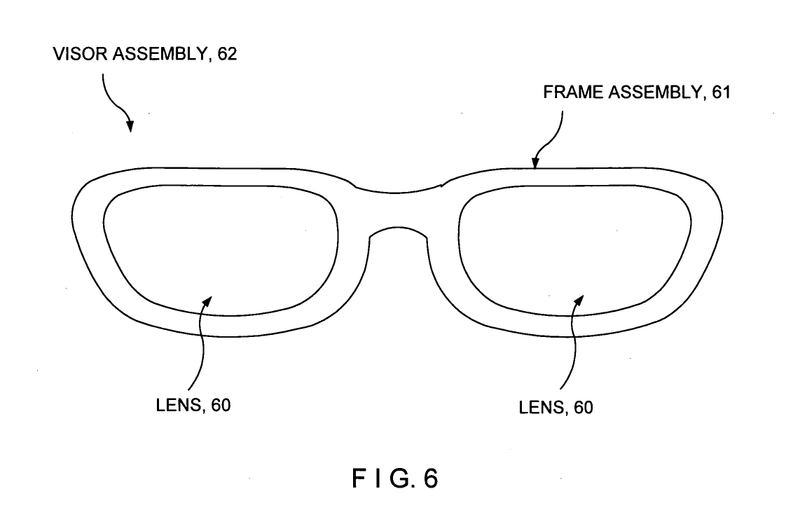

FIG. 1(a) shows a conventional lens arrangement (e.g., eyeglasses). The eyeglasses are composed of two lenses 10 and a frame assembly 11. The lenses 10 may be retained by the frame assembly 11 via a press fit or an adhesive bonding. The lenses 10 may be fabricated from material such as plastic or glass and can be polarized lenses. The frame assembly 11 may be fabricated from material such as plastic or metal. FIGS. 1(b) and 1(c) illustrate how the light emitted by light displays is received by the polarized lens 10 of a viewer 18 (person wearing the eyeglasses) using the lens arrangement of FIG. 1(a). The direction of the polarization of the lenses 10 is such that it minimizes the glare from an ambient light source 16 (e.g., sunlight, lamp, etc.) Ambient light is generally unpolarized, but can also include the glare which is generally horizontally polarized. The direction of polarization in the lenses 10 is not optimized for viewing LCDs 17.

FIG. 2(a) shows a first exemplary embodiment of a lens arrangement according to the present invention. The lens arrangement is composed of two lenses 20 and a frame assembly 21. As with the lens arrangement of FIG. 1(a), the lenses 20 of FIG. 2(a) may be retained by the frame assembly 21 via a press fit or adhesive bonding. The lenses 20 may be fabricated from material such as plastic or glass, and are preferably polarized lenses. The frame assembly 21 may be fabricated from plastic or metal materials. FIGS. 2(b) and 2(c) illustrate the polarized lens 20 of a viewer 28, i.e., a person wearing the lens arrangement of FIG. 2(a). As shown in FIG. 2(c), the direction of the polarization of the lenses 20 is such that it will maximize the light 27 emitted by the LCD, and as shown in FIG. 2(b) provide partial filtering of other light 26 (e.g., sunlight). The orientation of the lenses 20 is approximately 45 degrees with respect to the plane of visualization of the light. Furthermore, if two lenses are used, each may be independently polarized in a different orientation from the other to account for two different assembly orientations of LCDs in products. For example, one lens may be polarized at +45°, while the other can be polarized at −45° with respect to the plane of visualization of the light.

FIG. 3(a) shows a third exemplary embodiment of the lens arrangement according to the present invention. As with the first embodiment, the lens arrangement is composed of two lenses 30 and a frame assembly 31. Again, the lenses 30 may be fabricated of plastic or glass material, and are polarized and oriented so as to be able to reduce the glare from the sunlight and allow significant amount of light emitted from the LCD to pass therethrough. FIG. 3(b) shows the illumination of ambient light, its passage through the polarized lens 30 of the lens arrangement of FIG. 3(b) and entry into an eye 38 of a viewer 38. FIG. 3(c) shows the emission of light from the LCD, its passage through the lens 30, into the eye 38. The direction of the polarization of the lenses 30 is in a hybrid orientation, such that it allows an increased amount of the light 37 emitted by the LCD to pass therethrough, as opposed to the conventional lens arrangement of FIG. 1(a). For example, the polarized lenses 30 can be provided at approximately 30°-60° with respect to a horizontal orientation of the lenses. In particular, further partial filtering of certain unpolarized light 36 over the lens arrangement of FIG. 2(a) can be achieved.

FIG. 4(a) shows a third exemplary embodiment of the lens arrangement according to the present invention. This lens arrangement is composed of two bifocal lenses 40 and a frame assembly 41. As with the first and second embodiments of the lens arrangement of FIGS. 2(a) and 3(a), respectively, the lenses 40 may be retained by the frame assembly 41 via a press fit or adhesive bonding. Each portion of the lens 40 can include an upper portion 42 and a lower portion 43. The upper portion 42 of each lens 40 is configured and polarized to reduce the glare from the sunlight, and the lower portion 43 is configured and polarized to obtain the largest amount of light emitted from the LCD. The lenses 40 may be fabricated from material such as plastic or glass. FIGS. 4(b) and 4(c) pictorially illustrate this interaction between light displays and the polarized lens 40 of a viewer 49 using the lens arrangement of FIG. 4(a).

The direction of the polarization of the upper portion 42 of at least one of the lenses 40 is such that it will minimize or at least reduce glare from the ambient light 47 (e.g., sunlight, lamp, etc.). In other words, the orientation of the upper portion 42 of the lenses 47 is provided in the same direction as that of the conventional lens arrangement of FIG. 1(a), and is not optimized for viewing light generated by the LCDs 48. The direction of the polarization of the lower portion 43 of at least one of the lenses 46 is such that it preferably maximizes the receipt by the viewer 49 of the light emitted by the LCD 48. Thus, the orientation of the lower portion 43 of the lenses 46 is provided in the same direction as that of the lenses 20 of FIG. 2(a). The direction of polarization of the lower portion 43 of the lenses 46 may not be oriented to reduce the glare from the ambient light 47. In operation, when the viewer 47 is looking straight ahead, the lens arrangement of this exemplary embodiment provides maximum glare reduction (due to ambient light which is provided above the view direction) because the polarization direction in the upper portion 42 of the lens arrangement is oriented to reduce the polarized light emitted from such light source. When the viewer 47 is looking down, e.g., to view an automotive LCD-type dashboard, the lens arrangement is such that the attenuation of the light passing therethrough which originates from the LCD 48 is minimized, thus allowing an easier visualization of the images generated by the LCDs 48. Furthermore, if two lenses are used, the lower portion 43 of each may be independently polarized in a different orientation from the other to account for two different assembly orientations of LCDs in products. For example, one lower portion may be polarized at +45°, while the other can be polarized at −45° with respect to the plane of visualization of the light.

FIGS. 5(a)-5(c) show fourth, fifth and sixth exemplary embodiments, respectively, of the lens arrangement according to the present invention. The lens arrangements of FIGS. 5(a)-5(c) are composed of one or more lenses 50 and a frame assembly 51. The direction of the polarization of at least one or both of the lenses 50 is adjustable, and can be set by the viewer. For example, when the viewer is in an environment where glare reduction from ambient light is desired while viewing the light emitted from the LCD (e.g., while viewing an automotive dashboard while driving in sunlight), the viewer may set the lenses 50 in a hybrid orientation 56 such as that shown in FIG. 5(a). Such orientation may minimize the attenuation of the polarized light emitted by the LCD to improve the visualization of the image as opposed to the conventional lens arrangement of FIG. 1(a).

Alternatively, when the viewer/user is in an environment in which the glare reduction from the ambient light is desired, and the viewer is not viewing the LCD, such viewer may align the orientation 57 of the lenses 50 in the manner as shown in FIG. 5(b), which is approximately the same orientation as that of the conventional lens arrangement shown in FIG. 1(a) of the prior art. Such orientation of the lenses would likely provide a maximum reduction of glare. In addition, when the LCD is viewed in the sunlight, the viewer may align the orientation 58 of the lenses 50 as shown in FIG. 5(c). The orientation of the lenses 50 is approximately as shown in the exemplary embodiment of the lens arrangement of FIG. 2(a).

FIG. 6 shows a seventh exemplary embodiment of the lens assembly according to the present invention. This lens arrangement includes a visor assembly 62 that has two lenses 60 and a frame assembly 61. The visor assembly 62 may be affixed via magnets or retaining clips to eyeglasses. The polarization of the lenses 60 may be provided in substantially the same manner as the orientation of any of the aforementioned exemplary embodiments.

It is contemplated that many versions or embodiments of the invention may be provided. Although the invention has been described with a certain degree of particularity, it should be recognized that elements thereof may be altered by persons skilled in the art without departing from the spirit and scope of the invention. As such, the foregoing description has been presented for purposes of illustration and description. It is not intended to be exhaustive or to limit the invention to the precise form disclosed. Obvious modifications or variations are possible in light of the aforementioned teachings.

1. An arrangement adapted for viewing at least one liquid crystal display comprising:
at least one lens provided in a particular orientation so as to at least partially reduce an attenuation of a polarized light ray emitted by the at least one liquid crystal display.

2. An arrangement adapted for viewing at least one liquid crystal display comprising:
at least one lens, having a first portion and a second portion, the first portion being provided in a first orientation, the first orientation being arranged so as to at least partially reduce a glare from ambient light, the second portion being provided in a second orientation, the second orientation being arranged so as to at least partially reduce an attenuation of a polarized light ray emitted by the at least one liquid crystal display.

3. The arrangement according to claim 2, wherein the first portion is an upper portion of the lens, and wherein the second portion is a lower portion of the lens.

4. The arrangement according to claim 2, wherein the first orientation is substantially vertical with respect to a plane of visual light.

5. The arrangement according to claim 3, wherein the second orientation is arranged approximately 90° with respect to the first orientation.

6. The arrangement according to claim 3, wherein the second orientation is arranged approximately +45° with respect to the first orientation, measured counterclockwise from the perspective of a user.

7. The arrangement according to claim 3, wherein the second orientation is arranged approximately −45° with respect to the first orientation, measured counterclockwise from the perspective of a user.

8. The arrangement according to claim 1, wherein the particular orientation is arranged approximately +45° with respect to a horizontal orientation, measured counterclockwise from the perspective of a user.

9. The arrangement according to claim 1, wherein the particular orientation is arranged approximately −45° with respect to a horizontal orientation, measured counterclockwise from the perspective of a user.

10. An arrangement adapted for viewing at least one liquid crystal display comprising:
at least one lens provided in a selectable orientation so as to at least partially reduce an attenuation of a polarized light ray emitted by the at least one liquid crystal display.

11. The arrangement according to claim 10, wherein the selectable orientation is capable of being adjusted from approximately −90° with respect to a vertical plane of light measured counterclockwise from the perspective of a user to approximately +90° with respect to the vertical plane of light measured counterclockwise from the perspective of the user.
